(19) United States
(12) Patent Application Publication
(10) Pub. No.: US 2013/0055571 A1
(43) Pub. Date: Mar. 7, 2013

(54) ADJUSTABLE PREPARATION TOOL AND METHOD OF USE THEREOF

(71) Applicant: Adam Thomas Nugent, Canastota, NY (US)

(72) Inventor: Adam Thomas Nugent, Canastota, NY (US)

(73) Assignee: JOHN MEZZALINGUA ASSOCIATES, INC., East Syracuse, NY (US)

(21) Appl. No.: 13/223,334

(22) Filed: Sep. 1, 2011

(51) Int. Cl. H02G 1/12

(52) U.S. Cl. 30/90.1; 83/13

(57) ABSTRACT

Disclosed herein is a coaxial cable preparation tool that includes a main body and a cavity extending into the main body configured to accommodate insertion of a coaxial cable therein, the cavity including a first center axis. The coaxial cable further includes a first blade extending into the cavity. The first blade is rotatable about the cavity eccentric about the first center axis. The first blade is also variably securable in a fixed position with respect to the cavity and configured to cut the coaxial cable when the main body is rotated with respect to the coaxial cable.

### FIELD OF THE INVENTION

The subject matter disclosed herein relates generally to preparation tools for coaxial cables. More particularly, this invention provides for an adjustable preparation tool for coaxial cables of various diameters, and method of use thereof.

### BACKGROUND OF THE INVENTION

Coaxial cables are used as a transmission line for radio frequency signals for applications including but not limited to various communications networks. Many different types of coaxial cables exist having varying impedances and diameters. Coaxial cables may be, for example, 50 ohm impedance cables or 75 ohm impedance cables. These coaxial cables typically include an outer plastic jacket surrounding at least one outer conductor, both of which further surround a dielectric insulator. Housed within these three components is typically a center conductor for transmitting the transmission of signals.

To attach coaxial cables to communications systems, coaxial cables must generally be fitted with end connectors. Various types of end connectors exist for attaching the cables to various types of ports. To attach a connector to a coaxial cable, a preparation process must first be performed whereby a length of the outer jacket is first stripped. Further, the outer metallic conductor may also required to be cut, and a portion of the dielectric insulator may need to be removed. Preparation jacket cutting tools may be utilized to accomplish these functions. These cutting tools are configured to make a cut at a precise depth around the circumference of the coaxial cable so that the correct components of the coaxial cables are cut. However, because of the precision required, cutting tools are only capable of properly cutting a coaxial cable having an extremely small range of outer diameters. Unfortunately, variations in cable diameter may result from large tolerances or the fact that cables may be provided by different manufacturers. These coaxial cable diameter variations may result in the cable being: (1) too small to be properly stripped by a cutting tool; or (2) too large to fit within the dimensions of a cutting tool.

Accordingly, an adjustable preparation tool for a coaxial cable, and a method of use thereof, would be well received in the art.

### BRIEF DESCRIPTION OF THE INVENTION

According to one aspect, a coaxial cable preparation tool comprises: a main body; a cavity extending into the main body configured to accommodate insertion of a coaxial cable therein, the cavity including a first center axis; and a first blade extending into the cavity, the first blade rotatable about the cavity eccentric about the first center axis, the first blade variably securable in a fixed position with respect to the cavity, the first blade configured to cut the coaxial cable when the main body is rotated with respect to the coaxial cable.

According to another aspect, a coaxial cable preparation tool comprises: a main body; a cavity extending into the main body configured to accommodate insertion of a coaxial cable therein, the cavity including a first center axis; a collar surrounding the cavity, the collar having a second center axis that is eccentric with the first center axis, the collar securably rotatable about the cavity; and a blade housed within the collar and extending into the cavity, the blade configured to cut the coaxial cable when the main body is rotated with respect to the coaxial cable.

According to another aspect, a method of preparing a coaxial cable comprises: providing a coaxial cable preparation tool having a main body and a cavity, the cavity having a first center axis; rotating a blade within a cavity of a main body about a second center axis that is eccentric to the first center axis; retaining the blade in a position about the second center axis; inserting the coaxial cable into the cavity of the main body of a the coaxial cable preparation tool; rotating the main body around the coaxial cable; and cutting the coaxial cable with the blade.

According to another aspect, a coaxial cable preparation tool comprises: a main body; a cavity extending into the main body configured to accommodate insertion of a coaxial cable therein, the cavity including a first center axis; and a first blade extending into the cavity, the first blade rotatable about the cavity eccentric about the first center axis, the first blade variably securable in a fixed position with respect to the cavity, the first blade configured to cut the coaxial cable when the main body is rotated with respect to the coaxial cable.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of an adjustable preparation tool having a collar in a small outer cable diameter position accordance with one embodiment;

FIG. 2 depicts a perspective view of the adjustable preparation tool without the collar in accordance with one embodiment;

FIG. 3 depicts a cross sectional view at arrows 2-2 of the adjustable preparation tool of FIGS. 1-2 with the collar in a small cable outer diameter position;

FIG. 4 depicts a perspective view of the adjustable preparation tool of FIGS. 1-3 having a collar in a large outer cable diameter position accordance with one embodiment;

FIG. 5 depicts a cross sectional view at arrows 4-4 of the adjustable preparation tool of FIGS. 1-3 with the collar in a large cable outer diameter position in accordance with one embodiment;

FIG. 6 depicts a geographic representation of the circumferences and central axis of a main body and the collar of the adjustable preparation tool of FIGS. 1-5 in accordance with one embodiment;

FIG. 7 depicts a perspective view of another embodiment of an adjustable preparation tool with a collar removed in accordance with one embodiment;

FIG. 8 depicts a perspective view of the adjustable preparation tool of FIG. 7 with the collar attached in accordance with one embodiment;

FIG. 9a depicts a side cross-sectional view of an embodiment of a coaxial cable following preparation;

FIG. 9b depicts a side view of the coaxial cable of FIG. 9a;

FIG. 9c depicts a perspective view of the coaxial cable of FIGS. 9a and 9b;

FIG. 10a depicts a side cross-sectional view of an embodiment of a coaxial cable following preparation after a deeper cut than the embodiment shown in FIGS. 9a-9c;

FIG. 10b depicts a side view of the coaxial cable of FIG. 10a;

FIG. 10c depicts a perspective view of the coaxial cable of FIGS. 10a and 10b;

FIG. 11 depicts a perspective view of another embodiment of an adjustable preparation tool with two collars and two blades in accordance with one embodiment; and

FIG. 12 depicts an exploded view of another embodiment of an adjustable preparation tool with split halves for cutting a midpoint of a cable in accordance with one embodiment.

### DETAILED DESCRIPTION OF THE INVENTION

A detailed description of the hereinafter described embodiments of the disclosed apparatus and method are presented herein by way of exemplification and not limitation with reference to the Figures.

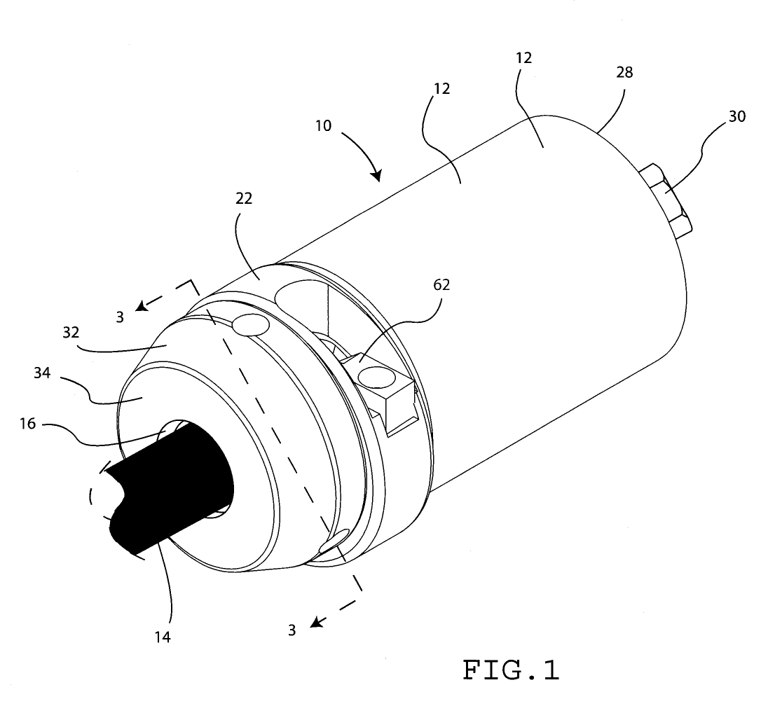

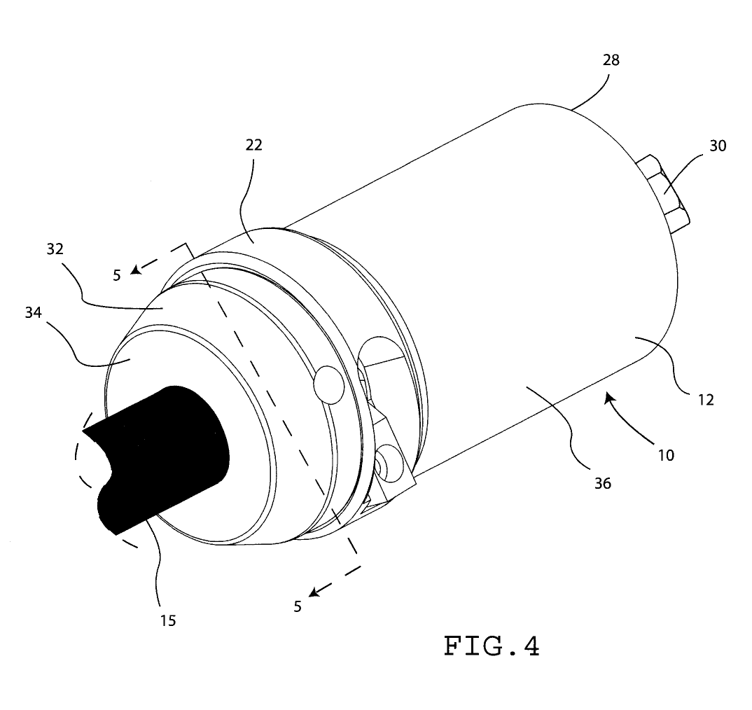

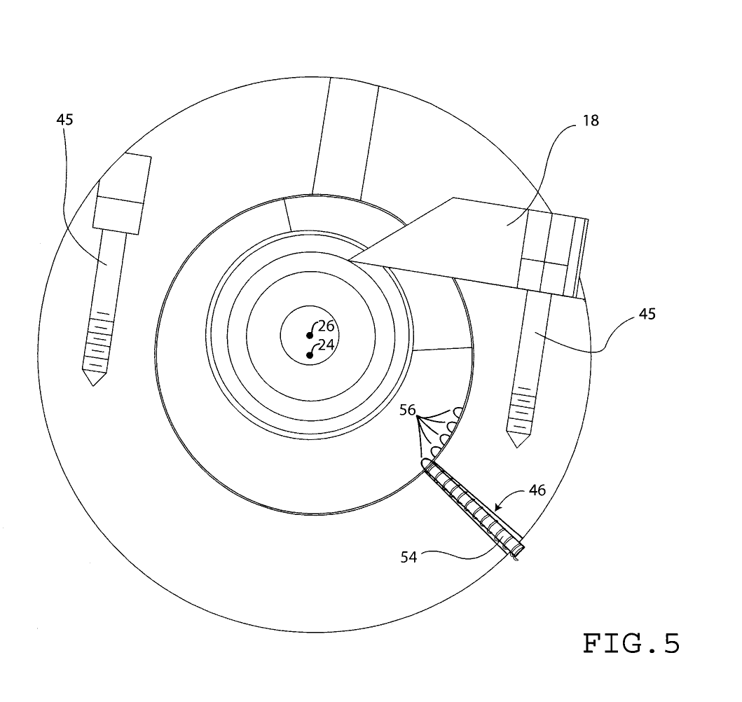

Referring to FIGS. 1-5, an adjustable preparation tool 10 is shown according to one embodiment. Shown in FIG. 1, the adjustable preparation tool 10 includes a main body 12 configured to receive an end of a smaller diameter coaxial cable 14 within a cavity 16. The main body 12 and the cavity 16 may share a first center axis 26. Shown in FIG. 4, the adjustable preparation tool 10 is shown similarly receiving an end of a larger diameter coaxial cable 15. Once the coaxial cable 14, 15 is received, at least one blade 18 within the cavity 16 may be brought into contact and pierce an outer plastic jacket 20 of the coaxial cable 14, 15. The adjustable preparation tool 10 may then be rotated about the coaxial cable 14 in order to make a circumferential cut in the outer plastic jacket 20 for removal during a cable preparation process. The adjustable preparation tool 10 may further include a collar 22 that houses the blade 18. The collar 22 may surround the cavity 16, but may include a second center axis 24 that is eccentric to the first center axis 26 of the main body 12. The collar 22 may rotate about the second center axis 24 and the cavity 16 in order to adjust the radial distance of the blade 18 with respect to the first center axis 26 of the main body 12 and cavity 16. This allows one to adjust the cutting depth of the blade 18 simply by rotating the collar 22 with respect to the main body 12 and about the cavity 16.

The main body 12 of the adjustable preparation tool 10 may be substantially cylindrical in shape. However, the main body 12 may also take any shape operable to appropriately prepare a coaxial cable. Extending from a first end 28 of the adjustment preparation tool 10 may be a post 30 so that the adjustment preparation tool 10 may be attached with a handle (not shown) for ease of manual rotation. The post 30 may have a hexagonal or square cross section or the like. The post 30 may also be a drive bit for attachment to a drive socket of an automatic drilling machine. A number of posts 30 may be attachable to the main body 12 for attachment to different drive sockets or handles. It should be understood that the main body 12 may be made of a metallic material, such as steel. Alternately, the main body 12 may be made of a plastic, or a composite or the like. Any material or combination of materials that would offer a sufficient product life may be appropriate. The main body 12 is shown as a single piece of material, such as a fashioned rod. However, in other embodiments contemplated, the main body 12 may be formed of multiple component elements joined or coupled together.

At a second end 34 of the adjustable preparation tool 10 may be the cavity 16. The cavity 16 may also be a hole, bore, gap, opening or the like. The cavity 16 may extend from the second end 34 along a central axis of the main body 12. The cavity 16 may extend an adequate length such that the coaxial cable 14 is insertable a sufficient distance past the collar 22 and the blade 18. Thus, the eventual cut of the blade 18 may be configured to remove the proper length of the outer plastic jacket for preparation of the coaxial cable 14. Furthermore, it should be understood that coaxial cables have many various thicknesses depending on the application. Different embodiments contemplated may have cavities 16 specifically sized to accommodate different types of coaxial cables. However, each embodiment is adjustable such that a range of dimensional tolerances of coaxial cables are receivable in the cavity 16 for proper jacket stripping. Furthermore, embodiments may include multiple cavities.

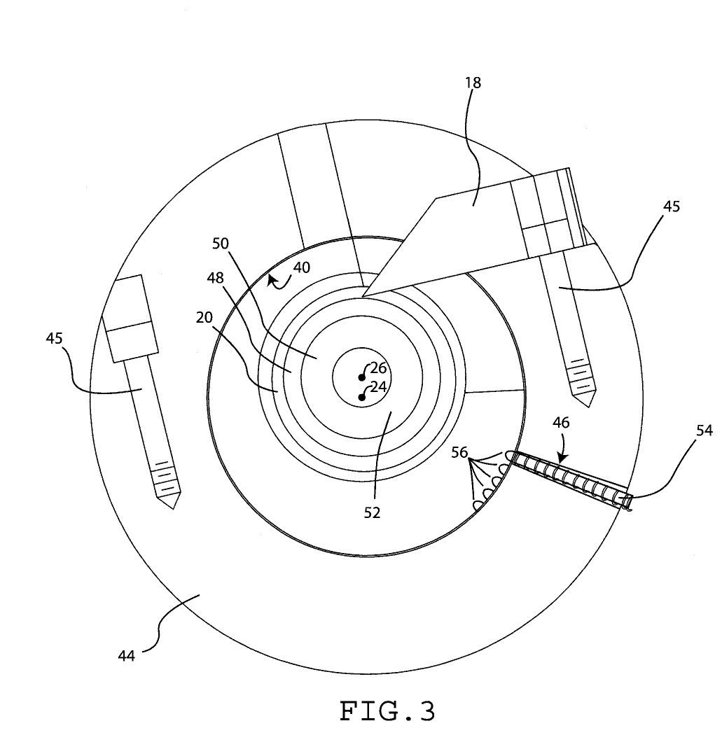

The adjustable preparation tool 10 may further include the collar 22 that houses the blade 18. The collar 22 may also be a ring, loop, hoop, band or other structure. Whatever the embodiment, the collar 22 is configured to surround the main body of the adjustable preparation tool 10. The collar 22 may be variably securable in a fixed position with respect to the cavity 16. Thus, the blade 18 may also be variably securable in a fixed position with respect to the cavity 16. The collar 22 may include two separate semi-cylindrical components 42, 44, as shown in the cross sectional view of FIG. 3. These components 42, 44 may allow the collar to be fashioned to the main body 12 of the adjustable prep tool 10. The collar components 42, 44 may be bolted together with bolts 45. It should be understood that other attachment means are contemplated in order to attach the collar 22 to the main body 12. Further, in other embodiments, the collar 22 may be a single integral component, while the main body 12 instead includes two separate attachable components. For example, a left portion 32 and a right portion 36 of the main body 12 may be separable. For example, a connecting portion 38 located between the left portion 32 and the right portion 36 of the main body 12 may be threaded on both sides in order to screw and unscrew the left and right portions 32, 36 of the main body 12. In other embodiments, the outer housing of the left portion 32 may be unscrewed from the remainder of the tool. For example, the right portion 36 and the connecting portion 38 may comprise a single piece. This piece may include a threaded portion that extends to the left (not shown) and accepts the housing of the left portion 32. Removal of this housing may allow a user to remove and reattach the collar 22 to the tool 10.

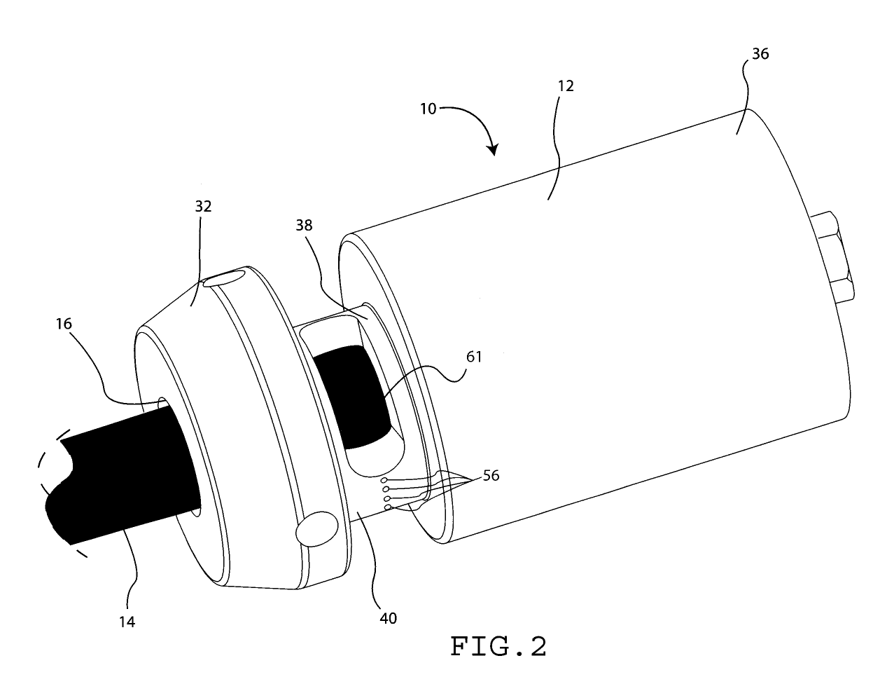

FIG. 2 shows the adjustable preparation tool 10 with the collar 22 removed in order to reveal the dimensions of the main body 12, including the left and right portions 32, 36, and the connecting portion 38. The connecting portion 38 may include an outer wall 40 and an opening 61 within which the blade 18 may extend into the cavity 16. The outer wall 40 of the connecting portion 38 may be concentrically aligned with the collar 22. Thus, both the collar 22 and the outer wall 40 of the connecting portion 38 of the main body 12 may have same second center axis 24. The outer wall 38 may have a circular cross section about which the collar 22 is configured to rotate. Further, the cavity 16 in the main body 12 having the first center axis 26 may extend through the connecting portion 38. However, the outer wall 38 of the connecting portion 38 and the cavity 16 may each have separate eccentric center axis: the first center axis 26 of the cavity 16 and the second center axis 24 of the collar 22 and outer wall 40 of the connecting portion 38.

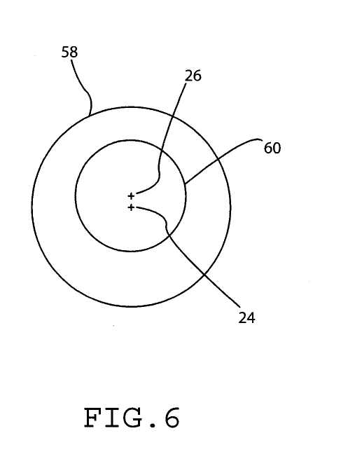

FIG. 6 shows a geographic representation of the eccentricity of the center axis of the cavity 16 and the collar 22 and the outer wall 40. This Figure further shows the first center axis 26 and the second center axis 24. These axes 24, 26 are shown as points, but it should be understood that these are actually parallel lines that extend through these points. In this Figure, an outer circle 58 represents the path that the center of the blade 18 takes when the collar 22 is rotated about the main body 12. An inner circle 60 represents the dimensions of the cavity 16 and the corresponding dimensions of the outer plastic jacket 20 of a coaxial cable 14, 15. It should be understood that the cutting edge of the blade 18 may have a smaller circumference that actually overlaps the inner circle 60. Thus, depending on the positioning of the collar 22 about the cavity 16, the blade 18 moves closer or further from the cavity 16 and the coaxial cable 14, 15. Further, as can be seen from this graphical representation, the blade 18 may be configured to rotate about the cavity 16 with a constant curvature.

The collar 22 may fit around the connecting portion 38 such that any rotation between the two components would be opposed with sliding friction due to a close dimensional fit. However, there may further be a securing mechanism 46 to secure the collar 22 into a position about the connecting portion 38 and prevent rotation of the collar 22 with respect to the connecting portion 38. The securing mechanism 46 may, for example, be a spring loaded plunger mechanism 54, shown in FIG. 3, which is housed within the collar 22 to move into one or more bores 56 found within the outer wall 40 of the connecting portion 38. The adjustable prep tool 10 may have a preset number of blade cutting depths that correspond to where the blade 18 lines up when the collar 22 is retained at these bore locations 56. In other embodiments, the collar 22 may house an acme thread bolt (not shown) that extends radially inwardly from the collar 22. The acme thread bolt may be rotated in order to move inward to engage with the connecting portion 38 and prevent rotation of the collar 22 with respect to the main body 12. This embodiment, or others, may provide for an infinite number of retainable rotational positions between the collar 22 and the main body 12.

Furthermore, the collar 22 may include an engaging mechanism 62 that is in communication with the blade 18. The engaging mechanism 62 may be utilized to disengage or engage the blade 18 from a cutting position. This may allow the coaxial cables 14, 15 to be inserted into the cavity 16 without interference from the blade 18. Once the coaxial cables 14, 15 are positioned within the cavity 16, the engaging mechanism 62 may be used to actually engage the blade 18 with the coaxial cable 14, 15 during the cut. In other embodiments, there is no mechanism to move the blade with respect to the collar 22. Instead, the blade 18 may be fixed with respect to the collar 22. In this embodiment, the coaxial cable 14, 15 may be cut by insertion into the cavity 16 and then rotation until the coaxial cable 14, 15 once the coaxial cable 14, 15 is in contact with the blade 18. The coaxial cable 14, 15 may then continue to be inserted during the rotational cutting 18 by the blade until the coaxial cable 14, 15 reaches the end of the cavity 16. Thus, the cavity 16 may be of a particular length to ensure a proper cutting length of the coaxial cable 14, 15.

Referring now specifically to FIGS. 1 and 3, the collar 22 of the adjustable preparation tool 10 is shown in a small cable outer diameter position after having received the smaller diameter coaxial cable 14. In this position, the blade 18 is located closer to the first center axis 26. Thus, the cutting edge of the blade 18 is configured to pierce the outer plastic jacket 20 of the smaller diameter coaxial cable 14 when the adjustable preparation tool 10 is rotated about the smaller diameter coaxial cable 14. In this cutting position, the blade 18 is tangential to the second center axis 24 and is located at a radial distance away from the second center axis 24.

In contrast to FIGS. 1 and 3, FIGS. 4 and 5 depict the collar 22 of the adjustable preparation tool 10 in a large outer cable diameter position after having received the larger diameter coaxial cable 15. In this position, the collar 22 has been rotated about the main body 12 with respect to the smaller outer diameter position. Thus, in this position, the blade 18 is located further from the first center axis 26 than in the smaller outer diameter position. Therefore, the cutting edge of the blade 18 is configured to pierce the outer plastic jacket 20 of the larger diameter coaxial cable 15 when the adjustable preparation tool 10 is rotated about the larger diameter coaxial cable 15.

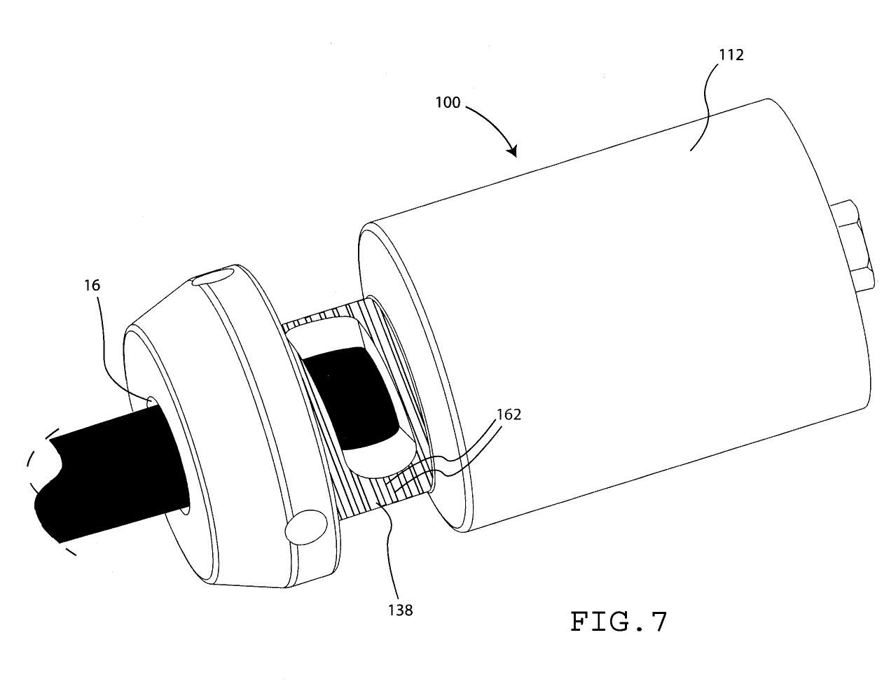

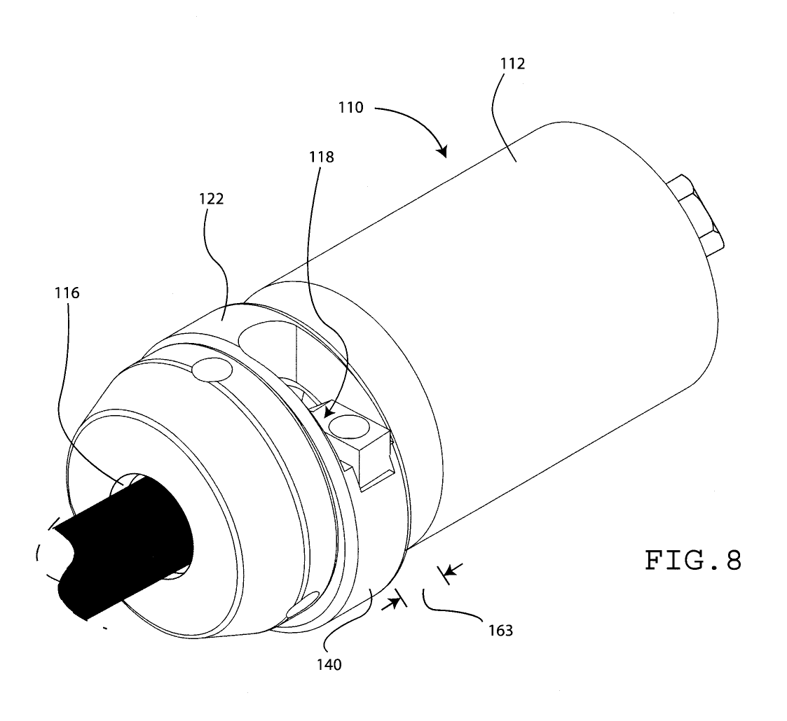

Referring now to FIGS. 7 and 8, another adjustable preparation tool 100 is shown. This adjustable preparation tool 100 is substantially similar to the adjustable preparation tool 10 described hereinabove. Thus, the adjustable preparation tool 100 includes a main body 112, a cavity 116, a blade 118 and a collar 122 similar to these features of the adjustable preparation tool 10. However, in addition to the features described in the previous embodiment, the collar 122 of the adjustable preparation tool 100 can be moved to the left and right along the first and second axis. In this embodiment, an outer wall 140 of a connecting portion 38 of the main body 112 of the adjustable preparation tool 100 may include threads 162. Similarly, the inner surface of the collar 122 may include corresponding threads (not shown). Thus, the collar 122 may be rotated by a user several full rotations in order to move the blade 118 to the left and right along the first and second axis. As shown in FIG. 8, the collar 122 is shown in a leftward position, with a space 163 between the collar 122 and the main body 112 to the right of the collar 122.

This may provide for the capability of the adjustable preparation tool 100 to more precisely cut different lengths in the coaxial cables 14, 15. For example, depending on the cable, it may be desirable to remove a greater or lesser length of the outer jacket. By moving the blade 118 to the left and right along the first and second axis, a user can change this cutting length of the coaxial cable 14, 15 without changing the amount that the coaxial cable 14, 15 is inserted into the cavity 116. Thus, the user may achieve different cutting lengths even though the coaxial cable is always fully inserted into the cavity 116 until it reaches the end of the cavity 116.

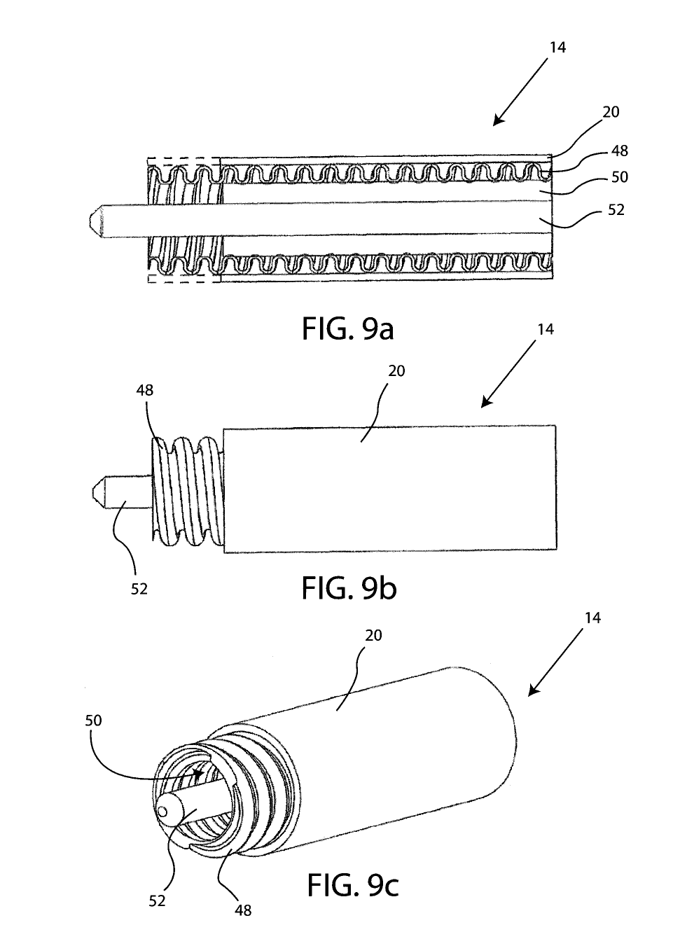

Referring now to FIG. 9a-9c, the smaller diameter coaxial cable 14 is shown after being prepared by the adjustable preparation tool 10. The smaller diameter coaxial cable 14 includes an outer jacket 20. The outer jacket 20 may be made of plastic, or other appropriate insulator. The outer jacket 20 surrounds the outer conductor 48 or metallic shield. The principles defined herein would extend to applications involving multi-outer conductor cables. Both the outer conductor 48 and the outer jacket 20 may further surround a dielectric insulator 50. Housed within these three components may be a center conductor 52 for transmitting the transmission of signals. While FIGS. 9a-9c do not show the larger diameter coaxial cable 15, it should be understood that the larger diameter coaxial cable 15 may be similar in all respects to the smaller diameter coaxial cable 14 shown in the Figures except for being dimensionally larger in diameter.

While the smaller diameter coaxial cable 14 shown in the Figures has a spiral walled outer conductor, it should be understood that the adjustable preparation tool 10 described herein may be applicable for preparing any types of coaxial cables. For example, a smooth walled outer conductor cable, an annular corrugated cable, or a braided outer cable may be prepared. It should be understood that some coaxial cables 14, 15 may include a plurality of outer conductors. The adjustable preparation tool 10 described herein would be useful in gripping and holding the jacket of any coaxial cable during preparation. It should be understood that preparation of the coaxial cable 14 may include removing a length of the outer jacket 20 and a lesser length of the outer conductor 48. Further, the preparation may include coring the dielectric insulator 50. Still further, preparation may include chamfering the tip of the center conductor 52. These preparation steps may be accomplished with the blades 42, 44, 46 within the cavity 16.

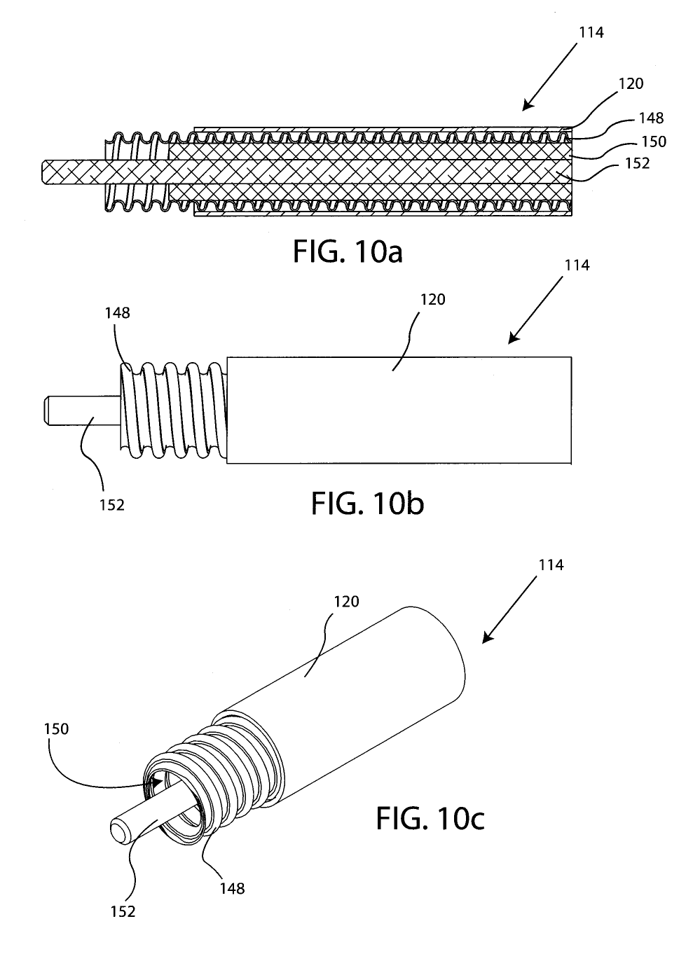

FIGS. 10a-10c show another smaller diameter coaxial cable 114 substantially similar to the smaller diameter coaxial cable 14. Thus, the smaller diameter coaxial cable 114 may include an outer jacket 120, an outer conductor 148, a dielectric 150, and a center conductor 152. However, unlike the smaller diameter coaxial cable 14 described hereinabove and shown in FIGS. 9a-9c, a greater length of the outer jacket 120 of the smaller diameter coaxial cable 114 shown in FIGS. 10a-10c has been cut. The difference in length between the coaxial cable 14 (shown in FIGS. 9a-9c) and the coaxial cable 114 (shown in FIGS. 10a-10c) may be achieved by utilizing the adjustable preparation tool 100. As described hereinabove, the blade 118 of the adjustable preparation tool 10 may also be adjustable along the center axes. Thus, the collar 122 of the adjustable preparation tool 100 may first be rotated to the left-most position, shown in FIG. 8, in order to cut the smaller diameter coaxial cable 118. Then, the collar 122 of the adjustable preparation tool 100 may be rotated to a right-most position (not shown), in order to cut the smaller diameter coaxial cable 18. It should be understood that the radial positioning of the blade 118 of the adjustable preparation tool 100 be similar when making both cuts, with the only difference being the positioning to the left and right of the center axes.

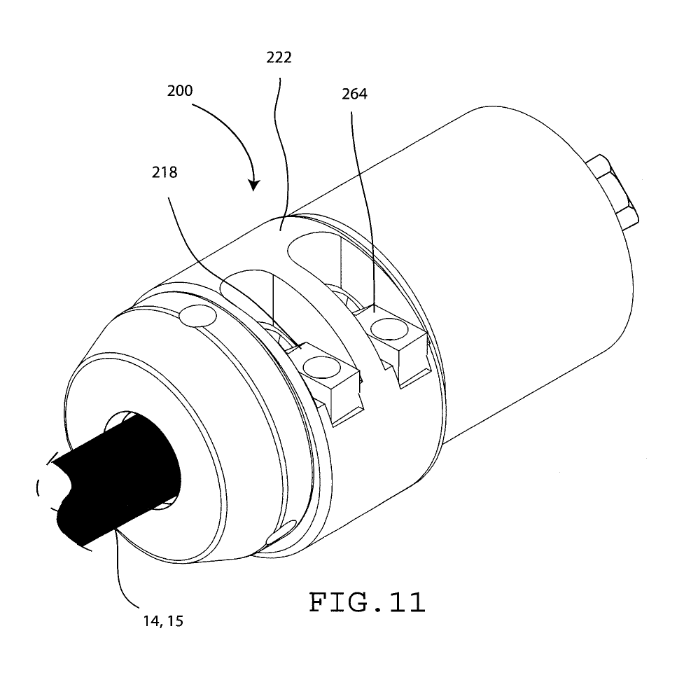

Referring now to FIG. 11, a perspective view of another adjustable preparation tool 200 is shown. The adjustable preparation tool 200 may be similar to the adjustable preparation tool 10 and 100 described hereinabove. However, unlike the above-described embodiments, the adjustable preparation tool may include a first blade 218 and a second blade 264. The first blade 218 and the second blade 264 may be housed within a single collar 222. The single collar 222 may be substantially similar to the collars 22, 122 described hereinabove. However, the collar 222 may be wider in order to accommodate the two blades 218, 264. The first blade 218 may be substantially similar to the blades 18, 118 described hereinabove. Thus, the first blade 218 may be the left-most blade and may be configured to cut the outer jacket 20 of a coaxial cable 14, 15. However, the second blade 264 may be located to the right of the first blade 218 and may be configured to cut either the center conductor 52 or the outer conductor 48.

While the embodiment shows a single collar 222 that houses both blades 218, 264, other embodiments are contemplated. For example, each blade 218, 264 may be housed in a different collar. Thus, the adjustable preparation tool 200 may include two or more rotatable collars. These collars may each be configured to separately rotate about the main body to move to the left and right independently, as described in the embodiment shown in FIGS. 7-8. Furthermore, a single collar 222 may be utilized that houses the blades 218, 264 on opposite radial of the annular collar 222. Thus, when one blade 218, 264 is in a proper cutting position, the other blade 218, 264 may be in a removed position that is farther from the second center axis 24.

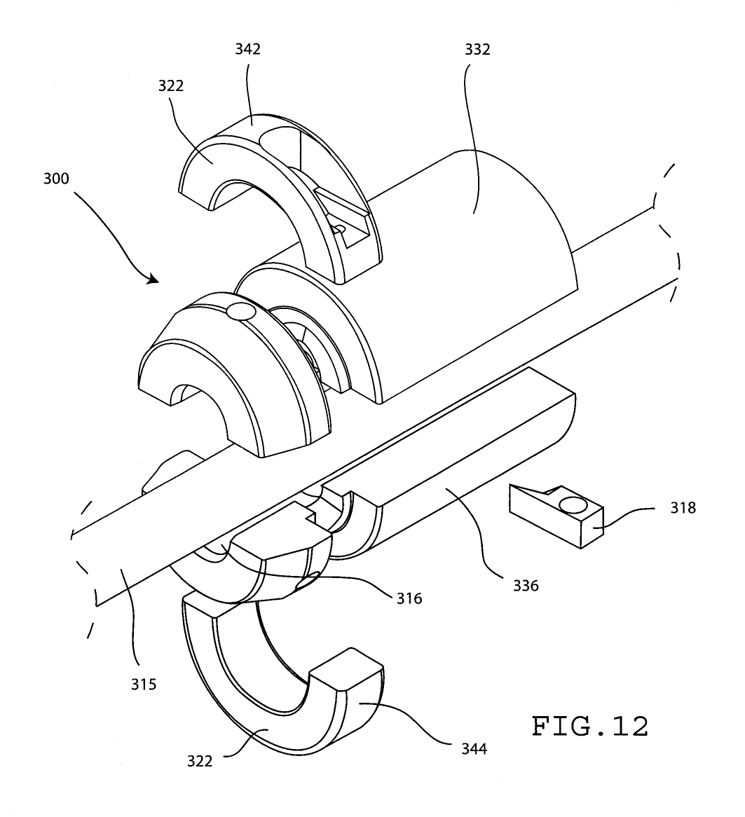

Referring now to FIG. 12, an exploded view of an adjustable preparation tool 300 is shown. This embodiment contemplates the need for cutting of a coaxial cable 315 at its midpoint rather than at its end. In this embodiment, rather than having the left and right portions 32, 36 of the main body 12 separately connectable as previously described, a main body 312 of the adjustable preparation tool 300 is separated along its length into a top portion 332 and a bottom portion 336. These portions 332, 336 may be bolted together or attached by any other appropriate means. In this embodiment, a cavity 316 may extend the entire length of the adjustable preparation tool 300 in order to accommodate the midpoint of the coaxial cable 315. Thus, the adjustable preparation tool 300 may be fashioned around a midpoint of the coaxial cable 315. In this embodiment, the adjustable preparation tool 300 may further include a collar 322 that houses a blade 318. The collar 322 is shown comprising two separate semi-cylindrical components 342, 344 as described hereinabove in the previous embodiments. Alternately, the collar 322 may be a single component ring. However the components of the adjustable preparation tool 300 are attached, the functionality of the eccentricity of the collar 322 and blade 318 may remain similar to the embodiments described hereinabove. Further, it should be understood that the top and bottom separability of the main body 312 as described in this embodiment may be applied to the multi-blade embodiment shown in FIG. 11.

A method of preparing a coaxial cable, such as the smaller diameter coaxial cable 14, is also contemplated. The method may first include providing a coaxial cable preparation tool, such as the coaxial cable preparation tool 10, having a main body and a cavity, such as the main body 12 and the cavity 16, the cavity having a first center axis such as the first center axis 26. The method may then include rotating a blade, such as the blade 18, within the cavity of the main body about a second center axis, such as the second center axis 24, that is eccentric to the first center axis. The method may include retaining the blade in a rotational position about the second center axis. The method may further include inserting the coaxial cable into the cavity of the main body of the adjustable preparation tool. The method may then include rotating the main body around the coaxial cable and cutting the coaxial cable with the blade. Still further, the method may include rotating a collar, such as the collar 22, having the second center axis about the main body, where the blade is fixedly housed within the collar.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A coaxial cable preparation tool comprising:
a main body;
a cavity extending into the main body configured to accommodate insertion of a coaxial cable therein, the cavity including a first center axis; and
a first blade extending into the cavity, the first blade rotatable about the cavity eccentric about the first center axis, the first blade variably securable in a fixed position with respect to the cavity, the first blade configured to cut the coaxial cable when the main body is rotated with respect to the coaxial cable.

2. The coaxial cable preparation tool of claim 1, further comprising a rotatable collar surrounding the cavity, the first blade housed by the collar, wherein the collar has a second center axis that is eccentric to the first center axis of the cavity.

3. The coaxial cable preparation tool of claim 2, further comprising a securing mechanism configured to prevent rotation of the collar during cutting of the coaxial cable.

4. The coaxial cable preparation tool of claim 2, wherein the collar comprises two separate semi-cylindrical components.

5. The coaxial cable preparation tool of claim 4, wherein the two separate semi-cylindrical components are bolted together.

6. The coaxial cable preparation tool of claim 1, wherein the first blade is configured to rotate about the cavity with a constant curvature.

7. The coaxial cable preparation tool of claim 2, wherein the second axis and the first axis are parallel.

8. The coaxial cable preparation tool of claim 1, wherein the first blade is tangential to the second center axis and is located at a radial distance away from the second center axis.

9. The coaxial cable preparation tool of claim 1, wherein the first blade movable about the second center axis.

10. The coaxial cable preparation tool of claim 1, further comprising a second blade extending into the cavity, the second blade rotatable about the cavity eccentric about the first center axis, the second blade variably securable in a fixed position with respect to the cavity, the second blade configured to cut a center conductor of the coaxial cable when the main body is rotated with respect to the coaxial cable, wherein the first blade is configured to cut an outer jacket of the coaxial cable.

11. A coaxial cable preparation tool comprising:
a main body;
a cavity extending into the main body configured to accommodate insertion of a coaxial cable therein, the cavity including a first center axis;
a collar surrounding the cavity, the collar having a second center axis that is eccentric with the first center axis, the collar securably rotatable about the cavity; and
a blade housed within the collar and extending into the cavity, the blade configured to cut the coaxial cable when the main body is rotated with respect to the coaxial cable.

12. The coaxial cable preparation tool of claim 11, further comprising a securing mechanism configured to prevent rotation of the collar during cutting of the coaxial cable.

13. The coaxial cable preparation tool of claim 11, wherein the collar comprises two separate semi-cylindrical components.

14. The coaxial cable preparation tool of claim 13, wherein the two separate semi-cylindrical components are bolted together.

15. The coaxial cable preparation tool of claim 11, wherein the blade is tangential to the second center axis and is located at a radial distance away from the second center axis.

16. The coaxial cable preparation tool of claim 11, wherein the collar and blade are both movable about the second center axis.

17. The coaxial cable preparation tool of claim 16, wherein the collar comprises a single component and wherein the main body comprises two separate components.

18. A method of preparing a coaxial cable, the method comprising:
providing a coaxial cable preparation tool having a main body and a cavity, the cavity having a first center axis;
rotating a blade within a cavity of a main body about a second center axis that is eccentric to the first center axis;
retaining the blade in a position about the second center axis;
inserting the coaxial cable into the cavity of the main body of a the coaxial cable preparation tool;
rotating the main body around the coaxial cable; and
cutting the coaxial cable with the blade.

19. The method of preparing a coaxial cable of claim 18, further comprising rotating a collar having the second center axis about the main body, wherein the blade is fixedly housed within the collar.

20. A coaxial cable preparation tool comprising:
a main body;
a cavity extending into the main body configured to accommodate insertion of a coaxial cable therein, the cavity including a first center axis; and
a blade extending into the cavity configured to cut the coaxial cable when the main body is rotated with respect to the coaxial cable;
a means for rotatably positioning the blade about the cavity such that rotation is eccentric about the first center axis.
